(19) United States
(12) Patent Application Publication
(10) Pub. No.: US 2005/0160654 A1
(43) Pub. Date: Jul. 28, 2005

(54) Decoy and movement system

(76) Inventor: Roberto Cosciani, Market Harborough (GB)

Correspondence Address: NEEDLE & ROSENBERG, P.C., SUITE 1000, 999 PEACHTREE STREET, ATLANTA, GA, 30309-3915, US

(21) Appl. No.: 10/765,467

(22) Filed: Jan. 26, 2004

(51) Int. Cl. A01M 31/06

(52) U.S. Cl. 43/2; 43/3

(57) ABSTRACT

A decoy and method of moving a decoy, the decoy having a body and a movement system for causing the decoy to move. The movement system comprising guide means connected to the body and drive means for driving the guide means so as to impart movement to the body in at least two directions simultaneously.

This invention relates to decoys in the form of birds or other animals and preferably in the form of an owl; more particularly, the invention is concerned with a movement system for such a decoy, which system imparts motion to the decoy or parts thereof in at least two different directions, or planes so as to simulate actions for example feeding or rotation coupled with wing flapping.

Hunters, photographers and participants in shooting sports use decoys to represent birds and other animals, normally to attract their quarry. Decoys may be water-borne, or may stand on or above solid ground. They may be motorised, or may simply move by natural wind power. Some such decoys have been developed to function by remote control. The term decoy is used herein also to encompass imitation birds or other animals, but preferably owls, which have a deterrent effect upon other birds or animals, in the manner of a ‘scarecrow’.

Many patents exist for decoys, both animated and non-animated, which cover a variety of different approaches. For example, U.S. Pat. No. 5,926,990 to Okimoto discloses a bird decoy movement system which imparts oscillatory motion in one plane.

U.S. Pat. No. 6,212,816 B1 to Babbit et al, shows an oscillating mechanism for motion in one plane, horizontal to the ground.

US patent application No 2001/0001913 A1 to Mathews utilizes a motor or natural wing power to impart motion to the wing members of a decoy.

Generally, the decoy movement associated with the prior art is limited which leads to a restricted and often repetitive form of simulated motion, often mimicking only a single action. This limitation of the decoy's movements may limit the scope of the decoy's use—the limited or regular movement may scare away the animals that the user wishes to attract, or may fail to have any positive impact in the intended field of use.

Those known decoy systems which seek to impart more life-like motion to a decoy are often so complex as to make them unreasonably expensive to produce—and thus expensive to the customer.

This invention seeks to overcome or at least mitigate the problems of the prior art, offering a solution to the development of a mechanically simple and therefore inexpensive movement system, which allows life-like movement of a decoy preferably constructed as an owl in a plurality of different of directions or planes.

One aspect of the invention provides a decoy having a body and a movement system for causing the decoy to move. The movement system comprises guide means connected to the body and drive means for driving the guide means so as to impart movement to the body in at least two directions simultaneously.

According to an optional feature of this aspect of the invention, the guide means may comprise a guide element and guide track for receiving the element and drive means is adapted to drive the guide track and guide element.

Preferably, the drive means comprises a rotary motor and an output arm adapted to be received by the guide track, whereby the rotary motion of the arm imparts a linear motion to the guide track. Preferably, the guide track is fixed to a pivot so that the arm imparts an oscillatory motion to the guide track.

According to an optional feature of this aspect of the invention, the guide track further comprises a slot for receiving the output arm to protrude there through to cause the guide element to move relative to the guide track.

In one class of embodiments, the guide element is pivotally connected to the guide track and wherein the output arm moves along a path on the guide element to cause the guide element to move in an oscillatory manner about the pivot.

Optionally, the guide element and body may also move from a horizontal plane in upward and downward directions about the pivot to simulate a nodding motion for the decoy.

In another class of preferred embodiments, the output arm is engaged by the guide element to cause it to move to and fro along the guide track.

The guide element may further comprise a protruding portion extending transversely and adapted to move along an edge of the guide track; the edge may be profiled to cause the protruding portion and part of the guide element to move relative to the guide track in a direction corresponding to the profile. Optionally, the protruding portion may be positioned to the rear of the guide element and the edge is profiled to cause the rear of the guide element to rise relative the front of the guide element as it moves towards the front of the guide track and to be lowered in the return direction so as to simulate a feeding motion for the body.

In preferred embodiments of the present invention, the decoy includes moveable wings connected to the body, the movement system incorporating means to cause oscillatory motion of the wings within a generally vertical plane or direction, to simulate wing flapping. This is especially the case for embodiments of the decoy constructed in the form of an owl.

According to an optional feature of the present invention, the guide element of the movement system further comprises a toothed rack to engage a cog arrangement secured to the guide track and connecting the wings via wires or rods so as to cause them to move.

A further optional feature provides that the guide element is connected to pivot means so as to convert linear motion of the guide element to oscillatory motion of the wings.

Ideally, the decoy incorporating the movement system is mounted on means to allow it to stand on or above solid ground, such as upon a fence or stake.

Exemplary embodiments of the invention will now be described, by way of example only, with reference to the accompanying drawings in which:—

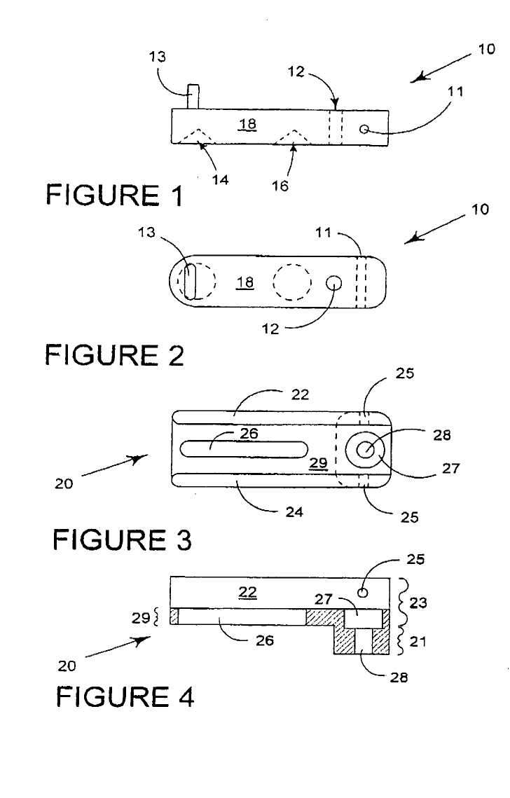

FIGS. 1 and 2 are side and plan views respectively of a guide element of the movement system for a decoy according to one embodiment;

FIGS. 3 and 4 are plan and side views respectively of a track apparatus of the movement system for a decoy according to one embodiment;

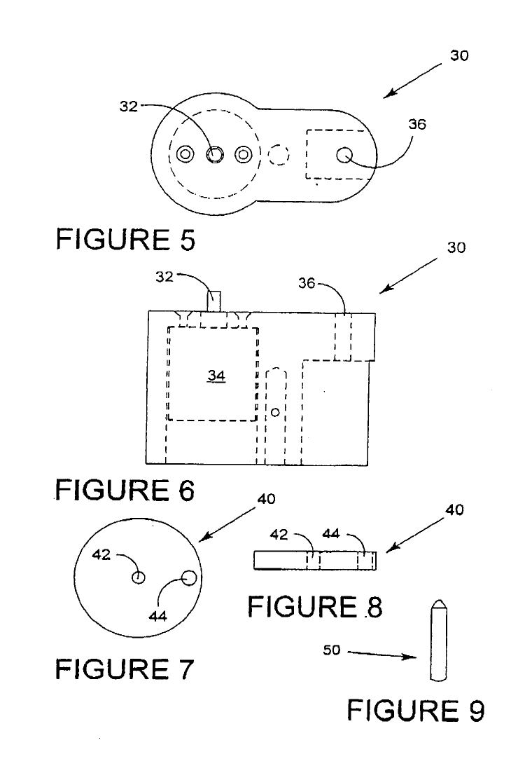

FIG. 5 is a plan view of the motor housing of the drive means;

FIG. 6 is a cut-away side-on view of the motor housing as shown in FIG. 5;

FIGS. 7 and 8 are plan and side views respectively of a rotary disc component of the drive means;

FIG. 9 is a side view of the pin element for use with the rotary disc;

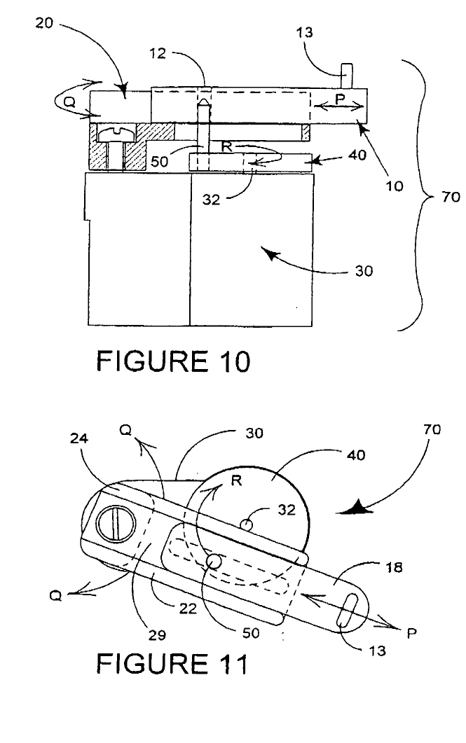

FIG. 10 is a side view of the assembled movement system for the decoy in a first embodiment;

FIG. 11 is a plan view of the assembled movement system as shown in FIG. 10;

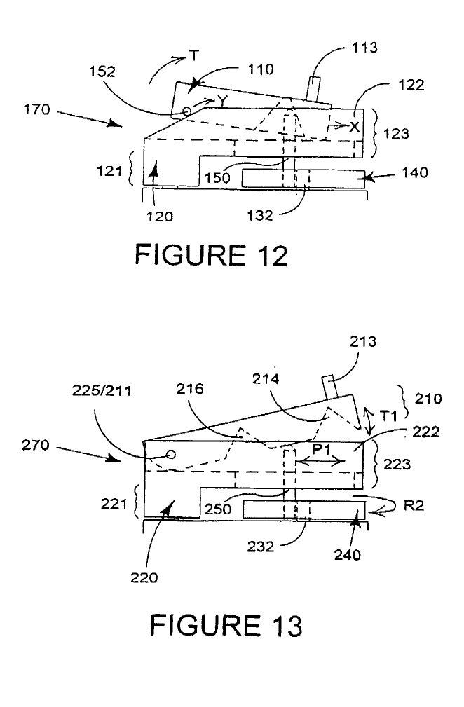

FIG. 12 is a side view of the guide element and guide track for a second embodiment of the invention;

FIG. 13 is a movement system, according to a third embodiment of this invention;

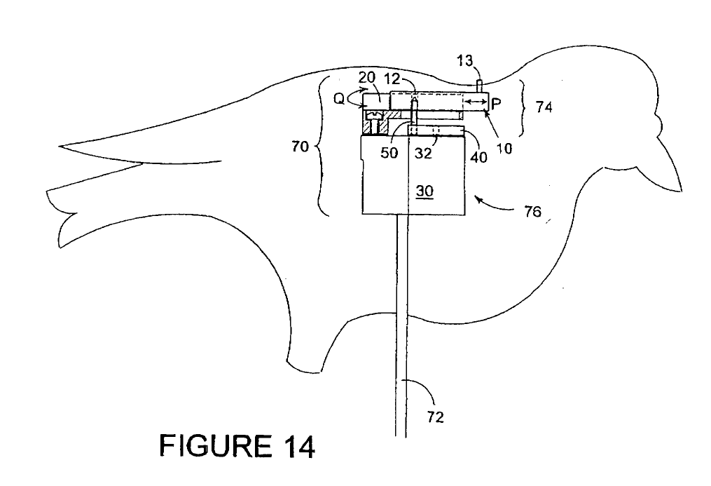

FIG. 14 shows how a movement system, according to any of the embodiments described herein, may be fitted to the body of a decoy;

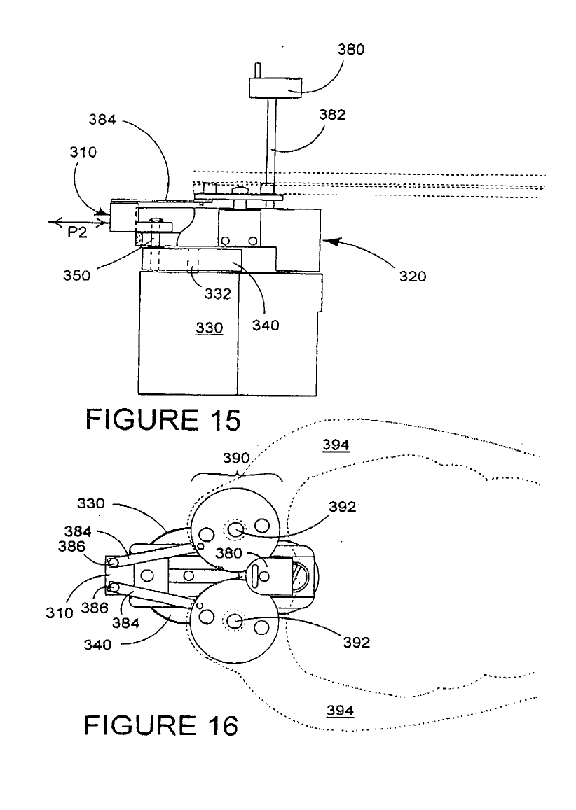

FIG. 15 shows, in a side-on view, how the movement system according to a fourth embodiment of the present invention may be constructed so as to facilitate oscillatory or rotatory motion of wing members;

FIG. 16 is a plan view of a decoy movement system according to the fourth embodiment of the present invention as shown in FIG. 15;

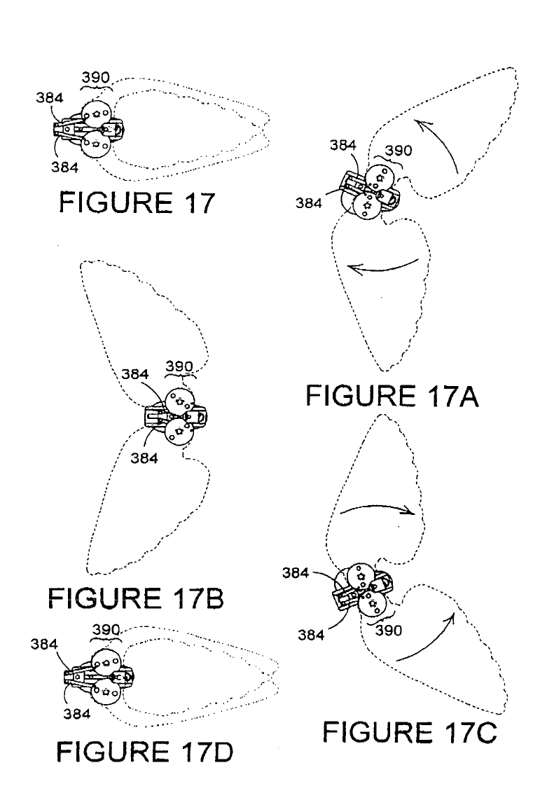

FIGS. 17, 17A, 17B, 17C and 17D show how oscillatory motion may be imparted to the wing members by a movement system according to the fourth embodiment of the present invention,

FIG. 18 is a view of a preferred owl decoy affixed to a movement system, with an internal arrangement of wires and fastening points therefor,

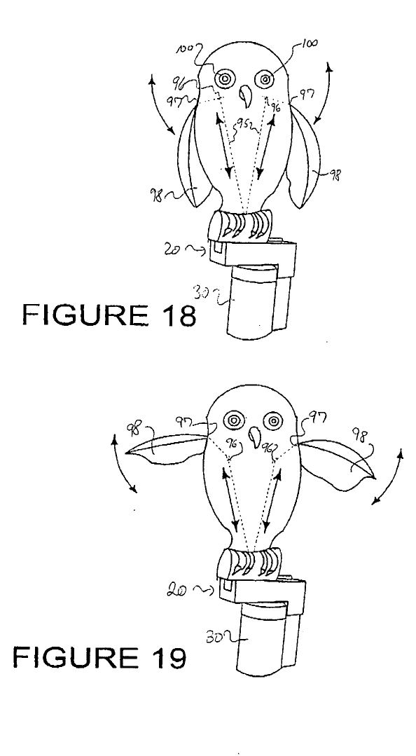

FIG. 19 is a view of the FIG. 18 preferred embodiment, depicting the vertical plane motion of its flapping wings, and

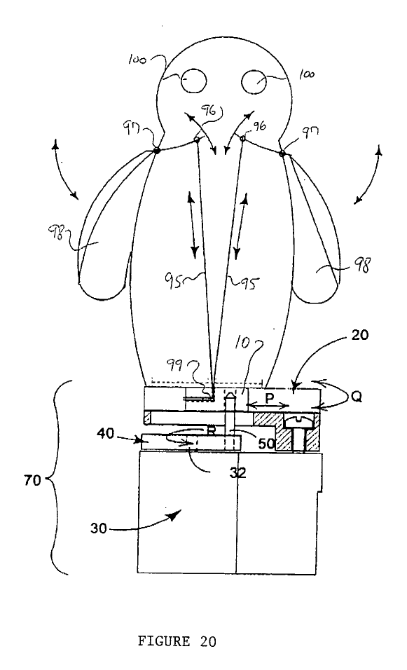

FIG. 20 is a cross-sectional view of the preferred embodiment of FIGS. 18 and 19 showing the direct connection as between the decoy body and the movement means.

Referring to the drawings and in particular FIG. 14, there is shown a decoy which is adapted to move. The decoy has a body 60 and a movement system 70 for causing the decoy to move. The movement system 70 comprises guide means 74 connected to the body 60 and drive means 76 for driving the guide means 74 so as to impart movement to the body in at least two directions simultaneously.

In order further to elucidate the scope of the present invention, a number of non-limiting exemplary embodiments of the invention will be described with reference to the accompanying drawings.

In preferred embodiments of this invention, the guide means 74 comprises a guide element 10 and a guide track 20. FIGS. 1 and 2 illustrate one suitable version of the guide element which comprises an arm 18, optionally, with an aperture 12 defined between the upper and lower surfaces of the guide element 10. Suitable engaging means, for example a pin 13 protrudes from the upper surface of the guide element 10; in use the pin allows the movement system 70, when assembled, to be fitted to the body shell 60 for the decoy.

FIGS. 3 and 4 show one suitable version of guide track 20, which comprises an upper portion 23 and a lower portion 21 connected to each other. The lower portion 21 includes a pivotal connection provided, in part, by aperture 28. The upper portion 23 comprises a track 29 for receiving the guide element 10; the track has defined in it an aperture 27, aligned with aperture 26 which is adapted to receive fixing means to form the pivot. In one class of embodiments, the track further comprises a slot 26 which is adapted to receive the output arm 50 of the drive means 76 described in more detail below. The upper portion 23 further comprises a pair of side wall panels 22 and 24, disposed either side of the track 29 to retain the guide element 10 within the guide track.

In some embodiments, a further aperture 25 is defined in each side wall panel 22 and 24 of the guide track 20 and there is a corresponding aperture 11 struck from the guide element 10 aligned with aperture 25 and to receive suitable fixing means to form a pivot connection between the guide track 20 and guide element 10.

In other embodiments the guide track 20 is so constructed and arranged as to allow the guide element 10 to move back and forth in the directions P as the output arm 50 is engaged in the aperture 12 and is driven by the drive means.

FIGS. 5 and 6 show the housing 30 for the drive means 76. In this embodiment, the housing 30 is provided with a recess to receive an electric motor 34 in such a way that the motor's drive shaft 32 protrudes from the upper surface of the motor housing 30 shown in FIG. 6. The motor is powered by an electric supply, for example a battery within the housing or more commonly a 12V battery positioned remote from the decoy and a suitable switching assembly. The motor is rated to provide a low rotary speed, for example 12-20 rpm. An aperture 36 is formed in the motor housing to provide a pivotal connection between the guide means 74 and the motor housing 30.

In order to convert a rotary motion from the drive means to movement to drive the guide means, means to offset the output motion is provided. In this embodiment the means comprises a rotary disc 40, and pin 50 which is mounted proximate the outer part of the disc to offset the drive, as shown in FIGS. 7, 8 and 9. The pin 50 is fitted to the disc through aperture 44. In other embodiments, the same effect is provided by making the drive shaft ‘dog leg’ in shape.

Defined at the centre of the disc 40 is an aperture 42, formed to cooperate with the drive-shaft 32 of the motor 34: when the rotary disc 40 is placed on the upper surface of the motor housing 30 in such a way that the aperture 42 accepts the motor drive shaft 32, and the motor is engaged, the rotary disc component 40 may rotate in the direction R. The disc 40 is secured to the drive shaft by suitable securing means, for example a grub screw positioned in aperture 46.

The guide means 74 and housing 30 is made from suitable plastics material so as to be light in weight and durable.

The movement system 70 is simple to manufacture and is achieved by mounting the motor in the housing 30 then securing the disc 40 to the drive shaft 32 so that it may be rotated in the direction R by engagement of the motor 34. The pin 50 is inserted into the recess or aperture 44 and secured thereto. The direction R is shown in FIGS. 9 and 10 as a clockwise rotation, although it is envisaged that an anti-clockwise rotation may equally be applied, to the same effect, to the rotary disc 40.

To complete construction of the movement system 70, the guide track 20 is, in this embodiment, pivotally connected to the motor housing 30 by suitable known fixing means secured to the housing, through apertures 28 and 36. The drive output arm 50 is received by the slot 26 to protrude therethough above the track 29.

When the drive means is switched on the rotary disc will rotate which will cause pin to rotate. The rotary movement of the pin 50 is converted to an oscillatory motion as it is moves to and fro within the slot 26. As the guide track 20 is pivotally connected to the housing 30, it will oscillate from side to side in the directions Q (FIGS. 10 and 11) as the rotary disc 40 rotates: thus the guide track 20 moves in a first direction and then returns as the pin 50 moves through 360 degrees.

In the first embodiment the pin 50 is engaged in aperture 12 of the guide element 10 to move it back and forth in the directions P within the track aperture 26. Oscillations back and forth are achieved by the tracing of such a path in the slot 26 by the pin element 50, as the rotary disc 40 rotates.

The combination of movement for the guide track 20 and the guide element 10 of the first embodiment is illustrated in FIG. 11.

A second embodiment of the present invention is illustrated in FIG. 12, wherein like numerals are adopted as for the first embodiment, but with the prefix “1” added. The second embodiment is similar to the first embodiment, so only the differences will be hereinafter described. In this second embodiment of the present invention, part of the side walls 122 and 124 of the track apparatus 120 is cut away as is illustrated in FIG. 12. A protruding portion, for example a pin 152 is inserted into the aperture 111, which is of a length greater than the distance between the side wall panels 122 and 124. It is so arranged as to allow part of the guide element to move relative the guide track. In this embodiment the protruding portion is towards the rear of the guide element 110 to trace a path following the side walls 122 and 124. It will be seen from FIG. 12 that the side walls 122 and 124 are truncated, so as to enable the rear part of the guide element to move in the direction Y as it is moved forward in the direction X. The pin 150 is inserted into an aperture 151, which aperture 151 is shaped to allow movement of the rear part of the guide element 110.

This arrangement imparts a diving or feeding motion, by moving the rear portion of the body shell 160 in the direction T, relative to the rest of the body shell 160.

A third embodiment of the present invention is illustrated in FIG. 13, wherein like numerals are adopted as for the first embodiment, but with the prefix “2” added. The third embodiment is similar to the first embodiment, so again only the differences will be hereinafter described. In this third embodiment of the present invention, the lower surface of the guide element 210 includes a linear cam-track, with, optionally, a non-uniform profile. FIG. I illustrates an example of an embodiment of the present invention in which the cam-track comprises a series of apertures or recesses 14 and 16. The guide element 210 is pivotally connected to the track apparatus by pivotal fastening means through the aligned apertures 25 and 11. In the third embodiment, however, as the pin 250 traces an oscillatory path back and forth within the track aperture 226, it also cooperates with the cam of the guide element 210 in a cam and follower arrangement, said guide element 210 being pivoted about a pivot installed in aligned apertures 225 and 211. Thus, the recesses 214, 216 impart a vertical “nodding” motion in the directions T to the decoy's body shell 260. This embodiment is illustrated in FIG. 13.

A fourth embodiment of the invention is shown in FIGS. 15 to 17D, wherein like numerals are used as for the first embodiment, but with the prefix “3” added. Only the differences between this present embodiment and the previous embodiments will hereinafter be described in any greater detail. In this embodiment, there is provided a static mounting 380 for the body of the decoy; the static mounting 380 is itself installed on a mounting rod 382. Further, the guide element 310 is connected by pivot arms 384 to pivot means 390, which pivot means 390 are fixed to the wing members 394.

The pin 350 protrudes through slot 326, and is connected to the guide element 310 so that said pin 350 may impart linear motion to the guide element 310 within the guide track 320. Consequently, rotation of the drive shaft 332 rotates the rotary disc 340, imparting linear motion in the directions P2 to the guide element 310 by action of the pin 350 as in previous embodiments. In this embodiment, such linear motion in the directions P2 of the guide element 310 further facilitates rotary motion of the pivot arms 384 about the guide pivots 386. This in turn causes rotary motion of the pivot means 390 about the wing pivots 392, which imparts oscillatory motion of the wing members 394.

In a still further alternative embodiment of the present invention, the side wall panels 22 and 24 comprise on their upper surfaces a toothed rack for the engagement of a pinion or cog arrangement, to convert the linear oscillation, in the directions P, of the pin 50 in the slot 26 to rotary motion of appendages to the body shell 60, for example wings.

In another embodiment, the movement system is mounted on means 72 to allow a decoy comprising that movement system to stand on solid ground. Alternatively, a further embodiment includes flotation means to allow a decoy comprising the movement system of the present invention to operate on water.

Referring to FIGS. 18 and 19, a preferred form of owl decoy is depicted, wherein a base of the body of the owl is affixed directly to the moving guide element 10 for movement therewith along the guide track 20, provided by the rotary drive means 30. The owl embodiment has a pair of wings capable of upward and downward motion i.e. within a generally vertical direction or plane.

A pair of wires or rods 95 are affixed to the guide element (as will be described subsequently with reference to FIG. 20), which wires or rods engage bearing or pivoting points 96 internally within the body of the owl. From these points 96, the wires or rods extend to connections 97 with the uppermost part of pivotally mounted wings 98. The wires or rods 95 are able to move in the directions shown by arrows in the figure, the wings capable of a flapping simulation also in the directions shown by arrows adjacent thereto.

The eyes 100 of the owl decoy are capable of illumination, operated by microswitch (not shown) activated by motion of the guide element 10. The construction and operation of this preferred embodiment is more readily apparent from FIG. 20, in which the same reference numerals as in FIGS. 18 and 19 have been used. Motion of the guide element 10 within the linear directions of arrow P, causes a lengthening or shortening of the wires or rods 95 and consequent wing motion of both wings 98. The pivot or connection points 96 may in themselves be movable as shown in the direction of the arrows.

In order to cause a positive return of the wings to a rest position, they may be spring or elastic-loaded.

The preferred owl embodiment of decoy is thereby capable of linear motion, at least partial rotation, wing flapping and eye illumination. As such it has a significant deterrent effect upon unwanted birds or other animals. The drive means 30 can be encapsulated to protect against the ingress of water or other harmful materials.

The present invention and its preferred embodiments provide a decoy which is capable of four axis, five axis or six axis movements and using a common design of guide means and drive means. It is envisaged that the movement system can be applied to a variety of decoy bodies, for example pigeon, duck, owl, goose or turkey, without departing from the scope of invention. It should further be recognised that terms of anatomy such as “wing” do not limit their respective mechanisms to such parts or configurations, but serve merely to distinguish such mechanisms from one another.

Furthermore, the flexibility of the system allows for different movement types to be applied for different decoy bodies according to particular user requirements The movement systems are able to be supplied new or to be fitted to existing decoy bodies on a retrofit basis.

1. A decoy having a body and a movement system for causing the decoy to move, the movement system comprising guide means connected to the body and drive means for driving the guide means so as to impart movement to the body in at least two directions simultaneously.

2. A decoy as claimed in claim 1 wherein the guide means comprises a guide element and guide track for receiving the element, wherein drive means is adapted to drive the guide track and guide element.

3. A decoy as claimed in claim 2 wherein the drive means comprises a rotary motor and an output arm adapted to be received by the guide track, whereby the rotary motion of the arm imparts a linear motion to the guide track.

4. A decoy as claimed in claim 2 wherein the guide track is fixed to a pivot so that the arm imparts an oscillatory motion to the guide track.

5. A decoy as claimed in claim 3 wherein the guide track further comprises a slot for receiving the output arm to protrude there through to cause the guide element to move relative to the guide track.

6. A decoy as claimed in claim 3, wherein the guide element is pivotally connected to the guide track and wherein the output arm moves along a path on the guide element to cause the guide element to move in an oscillatory manner about the pivot.

7. A decoy as claimed in claim 6, wherein the guide element and body move from a horizontal plane in upward and downward directions about the pivot to simulate a nodding motion for the decoy

8. A decoy as claimed in claim 3, wherein the output arm is engaged by the guide element to cause it to move to and fro along the guide track.

9. A decoy as claimed in claim 3, wherein the guide element further comprises a protruding portion extending transversely and adapted to move along an edge of the guide track, the edge being profiled to cause the protruding portion and part of the guide element to move relative to the guide track in a direction corresponding to the profile.

10. A decoy as claimed in claim 9 wherein the protruding portion is positioned to the rear of the guide element and the edge is profiled to cause the rear of the guide element to rise relative the front of the guide element as it moves towards the front of the guide track and to be lowered in the return direction so as to simulate a feeding motion for the body.

11. A decoy as claimed in claim 1, wherein the decoy further comprises one or more wings connected to the body, and the movement system further comprises means to facilitate oscillatory motion of the or each wing.

12. A decoy as claimed in claim 11, wherein the means to facilitate oscillatory motion is provided by the guide element of the movement system further comprising a toothed rack to engage a cog arrangement secured to the guide track and connecting the or each wing to cause it or them to move in an oscillatory fashion.

13. A decoy as claimed in claim 11, wherein the guide element is connected by an arm to the or each wing, the or each said wing being pivoted about a point spaced from the arm linkage, to convert linear motion of the guide element to oscillatory rotary motion of the or each wing.

14. A decoy as claimed in claim 1 wherein the movement system is mounted on means to allow it to stand on solid ground.

15. A decoy as claimed in claim 1 wherein the movement system is mounted on floatation means, thereby allowing the decoy to operate on water.

16. A decoy as claimed in claim 1 which is affixed directly to the movement system.

17. A decoy as claimed in claim 2 in which a base of the decoy is connected directly to the guide element.

18. A decoy as claimed in claim 17 in which the wings of the decoy are arranged to move in a generally vertical plane, the guide element being connected to said wings through an arrangement of wires or rods.

19. A decoy as claimed in claim 18, wherein the wires or rods engage mounting points internally within the body of the decoy.

20. A decoy as claimed in claim 19 wherein motion of the guide track causes respectively a lengthening of or shortening of the wires or rods to effect motion of the wings.

21. A decoy as claimed in claim 20 in the form of an owl decoy.

22. A decoy as claimed in claim 21 having simulated eyes which are adapted to illuminate and switching of the illumination is effected by motion of the said guide element.

23. A decoy as claimed in claim 22 in which the guide element, during motion, is adapted to engage a microswitch.

24. A method of imparting movement to a decoy wherein rotary movement of the drive shaft of a motor is converted to linear and oscillatory motion of a pivoted guide element, which guide element is driven within a guide track by drive means.

25. A method of imparting movement to a decoy as claimed in claim 24 as applied to a decoy having a body and a movement system for causing the decoy to move, the movement system comprising guide means connected to the body and drive means for driving the guide means so as to impart movement to the body in at least two directions simultaneously.
